(19) United States
(12) Patent Application Publication
(10) Pub. No.: US 2002/0172349 A1
(43) Pub. Date: Nov. 21, 2002

(54) Neural net-call progress tone detector

(76) Inventor: Phillip N. Shea, Rocklin, CA (US)

Correspondence Address: HEWLETT-PACKARD COMPANY, Intellectual Property Administation, P.O. Box 272400, Fort Collins, CO, 80527-2400, US

(21) Appl. No.: 09/859,687

(22) Filed: May 17, 2001

(51) Int. Cl. H04M 1/00

(52) U.S. Cl. 379/377

(57) ABSTRACT

An artificial neural network (ANN) based method and system for automatically optimizing the call progress detection system to a given telephone network environment. The artificial neural network learns or trains using real data to detect and recognize call progress tones or signals. The ANN system generally comprises a training component and a detection component. After the ANN is trained, the training component can be removed and only the detection component is installed on the telephone terminal device.

### TECHNICAL FIELD

The present invention relates in general to a method and apparatus for determining the state of a telephony call, and in particular to determining the telephony call progress tones in presence of speech.

### BACKGROUND

Present telephone terminal devices detect call progress signaling tones to determine or track the state of a telephony call, i.e., dialing, busy signal, phone message waiting, incoming call, etc. Generally, these call progress tones are generated by telephone companies using their central office switches. For example, in a typical plain ordinary telephone service (POTS) call, nine distinct signals or tones are generated:

1. When a calling party goes “off-hook”. The connect signal is sent over the calling party's line to the central office to which it is connected.

2. The central office replies with a steady dial tone, indicating that the equipment is ready for dialing.

3. The calling party then starts transmitting the address of the called party by dual tone multi frequency (DTMF) signaling.

4. The central office, after determining the appropriate outgoing trunk, seizes the trunk and transmits a connect or seizure signal to the next station. This signal requests service and hold the connection until the call is completed. This is generally referred to as forward signaling.

5. The destination central office, to which the called party is connected, transmits a ringing signal to the called party.

6. The destination central office also starts an audible ringing signal going, back to the calling party, to indicate that ringing has begun.

7. The called party, answering with an off-hook signal, starts an answer message going, back to the calling party.

8. Alternatively, a busy signal is sent back to the calling party. There are two types of busy signals: a) line busy tone indicating that the called line is busy, and b) reorder tone indicating that the network is busy. The reorder tone can result from no available paths, no available trunks, blockage in the equipment, etc. The reorder tone is set at twice the cadence frequency of the line busy tone.

9. Completion of the call is signaled by “on-hook” at either end. If the calling party completes (i.e., goes on-hook), a disconnect signal is sent to the called party. If the called party goes on-hook, a hangup signal is returned to the calling party.

As noted herein, when a caller or calling party picks up a handset or phone, the caller receives a dial tone generated by the telephone company's central office or exchange. However, as shown in FIG. 1, since the telephone terminal device can be off-hook when call progress detection system 100 is receiving call progress tones or signals 110 from central office 150, tone detectors 140 are susceptible to interference from the caller's voice or speech (i.e., near end speech) from handset 130 (not shown) passing through hybrid 120.

Hybrid 120 can represent a component or a group of components in telephone terminal device 100 that separates the incoming and outgoing signals on the two wires (not shown) connected to the telephone network, i.e., central office 150. Preferably, the caller's voice or speech received on handset 130 should not pass through hybrid 120 and onto tone detectors 140. However, tone detectors 140 are generally exposed to a significant amount of interference primarily due to variations in the telephone network characteristics, i.e., varying network equipments and/or environment.

Generally, there are two types of interference: “talkdown” and “talkoff”. Talkdown results when a caller's voice or speech drowns out the signaling tones, and talkoff occurs when tone detector 140 falsely detects voice or speech as signaling tones. It is appreciated that both types of interference are difficult to prevent since the operating frequencies of the call progress tones overlay with the human voice.

Additionally, the process of detecting the call progress tones is complicated because more than one call progress tones can use the same frequency but with different cadence. Cadence is an on/off pattern that can be used to modulate call progress tones 110.

Typically, tone detectors 140 use a series of filters to detect call progress tones 110. Since these call progress tones generally have two frequencies, tone detectors 140 typically use three bandpass filters and a level detection circuit connected to the output of these three filters to determine whether any call progress tones are present. The three bandpass filters generally comprise two bandpass filters operating at the expected frequencies of the call progress tones and a guard filter at other frequencies. For example, if tone detectors 140 receive noise containing signals at all frequencies, then all three filters (two bandpass filters and a guard filter) will output a signal, thereby indicating that the received signal is noise and not a call progress tone. Whereas, if tone detectors 140 receive a call progress tone, then only two bandpass filters will output a signal, thereby indicating that the received signal is a call progress tone. Accordingly, a microprocessor can be connected to the filters to determine the state of a telephone call (i.e., a call progress state) by detecting which filters have a signal.

However, call progress detection system 100 must operate with a human caller. For example, the caller may use the telephone, i.e., dialing the called party's telephone number (DTMF signaling), while the caller is talking, or in the presence of background noise from a television, an audio player, etc. Accordingly, tone detectors 140 must be optimized to obtain satisfactory talkoff and talkdown performance. However, it has been difficult to optimize current tone detectors 140 to meet industry performance standard or recommendations as established by Bellcore (now Telcorida Technologies). If the sensitivity of the tone detector is increased, talkoff increases, and if the sensitivity is decreased, talkdown increases. For these reasons, it is also difficult to design a logic algorithm for discriminating or detecting cadence. If the talkoff is high, the cadence patterns are corrupted with extra “on” periods. If the talkdown is high, the cadence patters are corrupted with extra “off” periods. However, if both talkoff and talkdown are present in the signal, both types of corruption can occur and designing a template to detect or identify the cadence is virtually impossible with the current known methodology.

Presently, the programmers or development engineers design and develop a telephone device or a call progress detection system (i.e., a prototype) by establishing the parameters of the filters, such as filter coefficients, sensitivity, etc., and developing template for detecting cadence (i.e., identifying signals) and algorithms to detect call progress tones using their skill and professional judgement, i.e., educated guess. The prototype is then tested in a simulated test environment, for example using Bellcore's audio tapes which simulate telephone conversations. The audio tapes contain essentially hours of talk radio programming wherein signal levels and frequency content have been calibrated or adjusted to simulate telephone conversation. While audio tapes are playing to simulate telephone conversation, various call progress tones are generated for detection by the prototype. The programmer then creates a new prototype (i.e, new tone detectors) based on the test results by adjusting the various filer parameters, shape of the templates, etc. This process is repeated until the prototype provides a desired level of performance. Unfortunately, this is very time consuming and tedious process that does not necessarily result in a call progress detection system that is optimized for talkoff and talkdown performance.

### SUMMARY OF THE INVENTION

The present invention is directed to a system and method which utilizes an artificial neural network (ANN) to automatically optimize the call progress detection system to a given telephone network environment. That is, the present technique not only reduces the design and development time of the call progress detection system, but provides a system that is optimized to provide superior talkoff and talkdown performance. The artificial neural network learns or trains using real data to detect and recognize call progress tones or signals. The ANN system generally comprises a training component and a detection component. After the ANN is trained, in accordance with an embodiment of the present invention, the training component can be removed and only the detection component is installed on the telephone terminal device. Accordingly, the telephone terminal device will comprise a trained ANN system for detecting call progress tones that is optimized to provide Bellcore's recommended talkoff and talkdown performance. This also advantageously lowers the cost of implementing and manufacturing the telephone terminal device.

In accordance with an embodiment of the present invention, the call progress detection system and method are provided for discriminating telephony call progress tones in the presence of background noise, i.e, speech, tv, radio, etc. The performance of the artificial neural network based discriminator or tone detector can be readily optimized to the target telephone network equipment and environment. That is, the tedious and time consuming process of designing, developing, redesigning and redeveloping prototypes is eliminated by the present invention. The ANN based system of the present invention can perform this time consuming optimization process using readily available microprocessor systems, preferably a high performance system. Thereafter, the trained ANN based system can then be integrated into the finished product, i.e., the telephone terminal device or call progress detection system of the present invention. Accordingly, the present invention advantageously provides a call progress detection system that is not simply based on educated guesses.

### BRIEF DESCRIPTION OF THE DRAWING

FIG. 1 is a block diagram of a typical prior art telephone terminal device for detecting call progress tones;

FIG. 2 illustrates the process of training and testing the artificial neural network in accordance with an embodiment of the present invention;

FIG. 3 is a block diagram of a telephone device in accordance with an embodiment of the present invention; and

FIG. 4 is a flow chart describing the process by which the tone detectors of the present invention process data.

### DETAILED DESCRIPTION

The present invention is readily implemented by presently available communication apparatus and electronic components. The invention finds ready application in virtually all commercial communications networks, including but not limited to a telephone network, a wireless network, and a wired cable transmission system.

As noted herein and shown in FIG. 1, call progress detection system 100 generally receives signals comprising a combination of call progress tones 110 and near end speech 130 as inputs. The near end speech can interfere or corrupt call progress tones 110, thereby complicating the task of detecting and identifying call progress tones 110. Also, the interfering near end speech can alter the cadence of call progress tones 110, thereby making it difficult to identify the cadence of call progress tones 110. Accordingly, the present invention proceeds upon the desirability of providing a call progress detection system that recognizes the cadences and call progress tones even in the presence of near end speech interference or corruption.

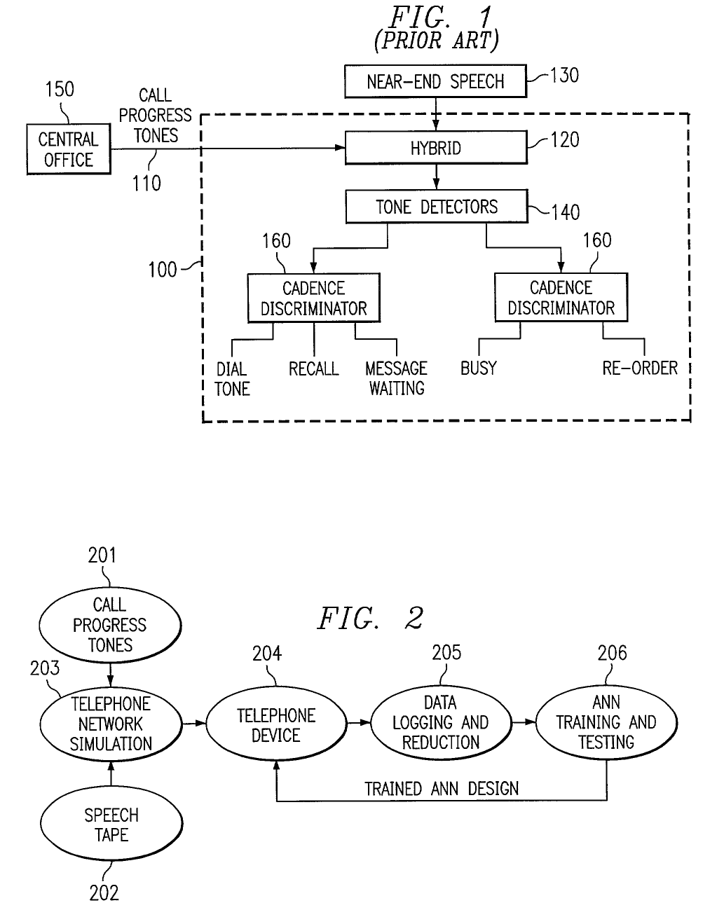

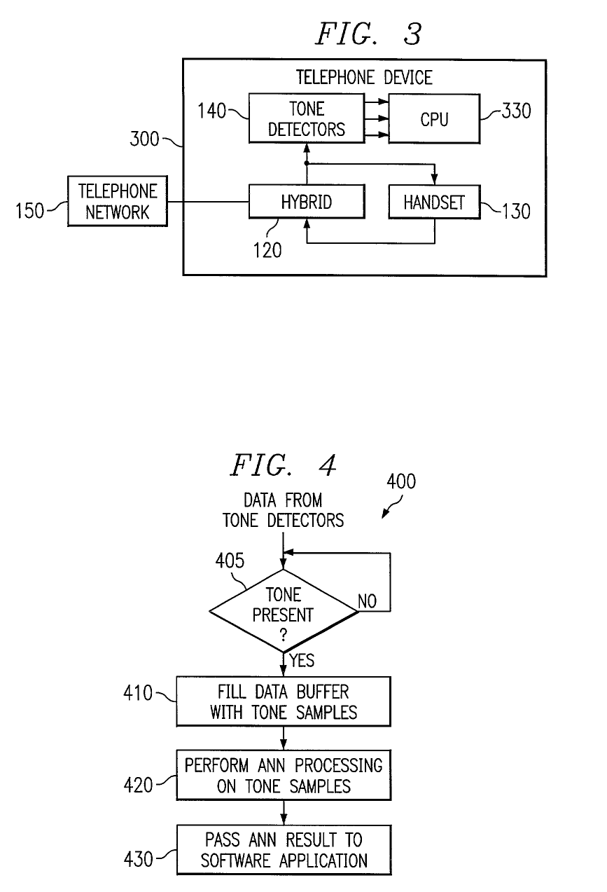

In accordance with an embodiment of the present invention, the call progress detection system comprises an artificial neural network (ANN) for determining the cadence of the call progress tones to identify the state of the telephone call. As shown in FIG. 3, telephone device 300 includes microprocessor 330 to track the state or progress of a telephone call, such as customer dialing, busy signal, message waiting, an incoming call, etc. Note that microprocessor 330 includes the ANN. Preferably, the system offers various options, i.e., redial, etc., to the caller or user based on the state of the telephone call. The ANN classifies samples of incoming call progress signals for the software operating or running on the telephone terminal device, i.e., operating system. The ANN is trained using actual data from the telephony environment external to telephone device 300. The trained ANN, less its learning component or functionality, is then installed within telephone device 300. This process is described in conjunction with FIG. 2 and will be discussed below.

Training data is acquired through telephone terminal device 300 (FIG. 3) into which the trained ANN is to be placed. This advantageously enables the ANN to consider such factors as, telephone device's and network's acoustic characteristics and hybrid performance. Preferably, the ANN is trained with Bellcore's analog display services interface (ADSI) test tapes, which have been specially tailored to match a statistical model of human speakers on the telephone network in step 202. An advantage of using the Bellcore tapes is that they may later be used by customers to evaluate the telephone device's suitability and performance in an ADSI environment. Therefore, the trained ANN in telephone device 300 is specifically adapted for use in its targeted environment and in the speech environment recommended by Bellcore.

All data collected for training is stored external to telephone device 300 and data is collected for each type of call progress tone in step 201. For each tone type, the cadence is varied throughout its timing tolerance. For example, call progress tones 110 can be generated repeatedly every ten seconds and mixed with the audio from the Bellcore test tapes in step 203. The audio mix is then played through a telephone network simulator to telephone device 300 in step 204. Samples from the telephone device's tone detection circuit are saved on a microcomputer's disk drive. It is appreciated that these samples are, by way of example, a stream of ones (representing tone detection) and zeros (representing no tone detection) and, in one embodiment, a sampling rate of 100 samples/second is sufficient to train the ANN. The data logging and reduction software residing in telephone device 300 then reduces the data by essentially storing a bit stream when call progress tones are detected in step 205. For example, the data logging and reduction software can extract samples following the detection of a call progress tone for 60 to 100 consecutive samples. Preferably, the collected samples are stored in files for later processing by the ANN.

In accordance with one embodiment of the present invention, a commercial PC based back propagation software package can be used to designed the ANN for use within telephone device 300 of the present invention. That is, the ANN back-propagates errors indicative of whether the call progress tones were properly detected and identified. The ANN is then trained using the tone data samples collected earlier until the desired error rate is obtained in step 206. If the desired error rate cannot be reached, then various ANN parameters, such as learning rate and number of hidden nodes, can be adjusted to retrain the ANN.

In accordance with another embodiment of the present invention, additional data can be collected using the same method as described herein for training the ANN. This collected data is used to test the trained ANN and to determine the error rate of the trained ANN in step 206. If the error rate is not acceptable, then the ANN parameters are again adjusted and the training process is repeated with the original data.

An artificial neural network is a learning circuit that can be either software or hardware. In a software application, the ANN uses parallel connected cells or nodes which are essentially memory locations linked by various weights. The present invention can utilize any artificial neural network that learns what the output should be based on a given set of inputs. After ANN is trained, the ANN's node interconnect weights are saved in a file. These weights are then applied to design, develop, produce and manufacture a simple feed-forward ANN for use in telephone device 300. It is appreciated that complexity of the original ANN is not required since the ANN residing within telephone device 300 is trained. That is, a copy of the ANN code, excluding codes relating to training, resides in CPU 330 of telephone device 300. In accordance with an aspect of the present invention, a hardware implementation of the ANN can include a data buffer and the ANN itself can be implemented in an ASIC or DSP chip. Alternatively, as shown in FIG. 3, a software implementation of the ANN comprises a tone detector interface to the CPU or microprocessor 330. Essentially, cadence discriminator 160 in FIG. 1 is replaced with CPU 330 comprising an ANN. It is appreciated that since those elements in FIG. 3 identified by the same reference numerals as those elements in FIG. 1 have been already described in reference to FIG. 1, they will not again be described in conjunction with FIG. 3.

In accordance with an embodiment of the present invention, FIG. 4 is a flow chart describing process 400 by which CPU 330 process the data or signals received from tone detectors 140. An inquiry is made in step 405 to determine the presence of call progress tones in the data or signal received from tone detectors 140 via hybrid 120. If the inquiry is answered in the negative, the CPU repeats step 400 until data containing call progress tone is received from tone detectors 140. However, if the inquiry is answered in the affirmative, CPU 330 stores the data (i.e., tone samples) in a data buffer (not shown) in step 410 and transmits the data to the ANN. The ANN process the data (tone samples) to identify call progress tones in step 420 and then transmits the result to the application software which determines the state of the call based on the identified call progress tones in step 430. The application software residing in telephone device 300 may also offer various options to the caller based on the call progress tones.

What is claimed is:

1. A method of determining the state of a telephony call, comprising the steps of:
providing a trained artificial neural network system for determining call progress tones from an input signal associated with said telephony call; and
employing said trained neural network system for determining the call progress tones and the state of said telephony call based on determined call progress tones.

2. The method of claim 1 wherein said trained neural network system determines the call progress tones in presence of near end speech to optimize talkoff and talkdown performance.

3. The method of claim 1 further comprising the step of providing one or more call options to a caller based on the determined state of said telephony call.

4. The method of claim 1 wherein said artificial neural network system is implemented in hardware.

5. The method of claim 1 wherein said artificial neural network system is implemented in software.

6. A method for providing an artificial neural network system for determining the state of a telephony call, comprising the steps of:
providing an artificial neural network system for determining call progress tones from an input signal associated with said telephony call; and
training said artificial neural network system using a telephone network simulator to determine call progress tones from a plurality of signals.

7. The method of claim 6 wherein the step of training comprises the step of back-propagating an error indicative of whether the call progress tones were properly determined.

8. The method of claim 6 wherein said plurality of signals comprises call progress tones mixed with audio from Bellcore's ADSI test tapes.

9. The method of claim 6 wherein the step of training comprises the step of sampling said plurality of signals at 100 samples/second to train said artificial neural network system.

10. The method of claim 6 wherein the step of training comprises the step of adjusting one or more artificial neural network parameters until an error rate is at or below a predetermined error rate.

11. The method of claim 10 wherein s aid parameters include at least one of the following: learning rate and number of hidden nodes.

12. Apparatus for determining the state of a telephony call, comprising:
a trained neural network system for determining the call progress tones from an input signal associated with said telephony call and the state of said telephony call based on the call progress tones.

13. The apparatus of claim 12 wherein said trained neural network system determines the call progress tones in presence of near end speech to optimize talkoff and talkdown performance.

14. The apparatus of claim 12 wherein said neural network is operable to provide one or more call options to a caller based on the determined state of said telephony call.

15. The apparatus of claim 12 wherein said artificial neural network system is implemented in hardware.

16. The method of claim 12 wherein said artificial neural network system is implemented in software.

17. Apparatus for providing artificial neural network system for determining the state of a telephony call, comprising:
an artificial neural network system for determining call progress tones from an input signal associated with said telephony call; and
means for training said artificial neural network system using a telephone network simulator to determine call progress tones from a plurality of signals.

18. The apparatus of claim 17 wherein said means for training is operable to back-propagate an error indicative of whether the call progress tones were properly determined.

19. The apparatus of claim 17 wherein said plurality of signals comprises call progress tones mixed with audio from Bellcore's ADSI test tapes.

20. The apparatus of claim 17 wherein said means for training is operable to sample said plurality of signals at 100 samples/second to train said artificial neural network system.

21. The apparatus of claim 17 wherein said means for training is operable to adjust one or more artificial neural network parameters until an error rate is at or below a predetermined error rate.

22. The method of claim 21 wherein said parameters include at least one of the following: learning rate and number of hidden nodes.
